(19) United States
(12) Patent Application Publication
(10) Pub. No.: US 2009/0160314 A1
(43) Pub. Date: Jun. 25, 2009

(54) EMISSIVE STRUCTURES AND SYSTEMS

(75) Inventors: Sergiy Zalyubovskiy, Niskayuna, NY (US); William Paul Minnear, Clifton Park, NY (US); Gregory John Parker, Latham, NY (US); Vikas Midha, Clifton Park, NY (US)

Correspondence Address: GENERAL ELECTRIC COMPANY;GLOBAL RESEARCH, PATENT DOCKET RM. BLDG. K1-4A59, NISKAYUNA, NY, 12309, US

(73) Assignee: GENERAL ELECTRIC COMPANY, Schenectady, NY (US)

(21) Appl. No.: 11/961,829

(22) Filed: Dec. 20, 2007

(51) Int. Cl. H01J 1/62; H01J 17/20

(52) U.S. Cl. 313/498; 313/643

(57) ABSTRACT

An emitter is disclosed. The emitter includes a base layer, where the base layer includes an emissive region of nanocavities and wherein the base layer includes hafnium and nitrogen. A radiation source including the emitter is also disclosed.

### BACKGROUND

The presently claimed invention relates to emissive structures and related systems.

Conventional tungsten filament lamps exhibit low luminous efficacy (˜17 1 m/W for a 120 V, 750 h, 100 W lamp) compared to plasma discharge or fluorescent lighting sources. In tungsten incandescent lamps only 5-10% of radiation is emitted in the visible spectral range (390-750 nm). The rest is emitted as thermal infrared radiation, primarily in the 750-4000 nm spectral range. The efficiency of the incandescent lamp can be improved by simultaneous enhancement of the radiation emitted in the visible and suppression of the infrared radiation.

Periodic photonic lattices have the unique property that radiation of specific wavelengths cannot propagate through the lattice. Enhanced efficiency in visible wavelengths can be achieved if the photonic lattice is configured to increase visible absorption and/or suppress IR emission. Unfortunately, many of the photonic lattices are limited to low temperature, less than 1000 degrees K, operation due to thermal instabilities.

Therefore, it would be advantageous to develop high temperature emitters with tailored emission properties.

### BRIEF DESCRIPTION

In accordance with one aspect of the disclosure, an emitter is disclosed. The emitter includes a base layer, wherein the base layer includes an emissive region of nanocavities and wherein the base layer includes hafnium and nitrogen.

In accordance with another aspect of the disclosure, a radiation source is disclosed. The radiation source includes a base, a light-transmissive envelope coupled to the base, and an emitter including a base layer, wherein the base layer includes an emissive region of a periodic two-dimensional array of nanocavities and wherein the base layer includes hafnium and nitrogen.

### DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic view of an emitter in accordance with one embodiment of the present invention;

FIG. 2 illustrates schematic cross-sectional view of an emissive region in accordance with one embodiment of the present invention;

FIG. 3 illustrates schematic cross-sectional view of an emissive region in accordance with another embodiment of the present invention;

FIG. 4 illustrates schematic a top view of an emissive region with a hexagonal lattice of nanocavities in accordance with one embodiment of the present invention;

FIG. 5 illustrates schematic top view of an emissive region with a simple square lattice of nanocavities in accordance with one embodiment of the present invention;

FIG. 6 is a micrograph of a hafnium nitride emitter including a periodic array of nanocavities in accordance with one embodiment of the present invention;

FIG. 7 illustrates measure variation in emissivity with wavelength for a tungsten emitter, a hafnium nitride emitter and a hafnium nitride periodic array of nanocavities in accordance with one embodiment of the present invention;

FIG. 8 illustrates the variation with wavelength of the measured ratio of hafnium nitride nanocavity emissivity with hafnium nitride base layer emissivity in accordance with one embodiment of the present invention;

FIG. 9 illustrates a comparative plot between calculated and measured spectral emissivity for varying cavity diameters in accordance with one embodiment of the present invention;

FIGS. 10-14 illustrate examples of emitter filaments in accordance with embodiments of the present invention;

FIG. 15 illustrates an incandescent lamp including an emitter in accordance with one embodiment of the present invention;

FIG. 16 illustrates an incandescent lamp including an emitter in accordance with another embodiment of the present invention; and

FIG. 17 illustrates an incandescent lamp including an emitter in accordance with another embodiment of the present invention.

### DETAILED DESCRIPTION

In accordance with one or more embodiments of the presently claimed invention, emitters, and radiation sources including the emitters will be described herein. In the following description, numerous specific details are set forth in order to provide a thorough understanding of various embodiments of the present invention. However, those skilled in the art will understand that embodiments of the present invention may be practiced without these specific details, that the present invention is not limited to the depicted embodiments, and that the present invention may be practiced in a variety of alternative embodiments. In other instances, well known methods, procedures, and components have not been described in detail.

Furthermore, various operations may be described as multiple discrete steps performed in a manner that is helpful for understanding embodiments of the present invention. However, the order of description should not be construed so as to imply that these operations need be performed in the order they are presented, or that they are even order dependent. Moreover, repeated usage of the phrase “in one embodiment” does not necessarily refer to the same embodiment, although it may. Lastly, the terms “comprising”, “including”, “having”, and the like, as used in the present application, are intended to be synonymous and interpreted as open ended unless otherwise indicated.

As used herein the term “temperature stable’ or “temperature stability” refers to the structural stability at the stated temperatures.

As used herein, the term “periodicity of distribution” is intended to refer to the center-to-center spacing by which two or more cavities may be separated. In the event a specific numerical value for a periodicity of distribution is provided herein, a margin of error of ±10 percent may be assumed.

Material surfaces modified with regularly spaced cavities are expected to display several distinct absorption features that may be utilized in tailoring absorption spectra. Electromagnetic (EM) fields localized or confined inside the cavity volume will exhibit a strong dependence on the width dimension of the cavity, such as the diameter of the cavity. This phenomenon is an intermediate case between coupling of the EM radiation into a resonant cavity and confinement of the radiation within a waveguide. In all cases, there is specific cut-off frequency below which electromagnetic radiation cannot interact with a given cavity. The exact frequency of this lowest energy “volume” mode depends on cavity geometry and dielectric properties of the base material. Deviation of the material properties from ideal metallic behavior will result in penetration of the electromagnetic fields into the structure thus shifting the frequencies of the “volume” modes towards the blue part of the spectrum.

Periodic variation of dielectric properties along the surface of the material may also result in excitations propagating along the interfaces. Surface modes are EM fields localized or confined on the surface and exhibit a strong dependency on the periodicity or pitch of the cavities. These “surface” modes can occur only if the momentum wavevector of the collective surface oscillations is conserved. That is, the collective surface oscillations are equal to the combined momentum of the photon and periodic array. This condition will also define exact frequencies of the “surface” modes and pose constrains on material sets with dielectric properties capable of supporting such surface modes.

In one embodiment of the present invention is a periodic array of nanocavities with selectively enhanced energy absorption centered at a desired center or peak wavelength due to absorption induced by volume modes and/or surface modes. In certain embodiments, the base layer material is chosen such that dielectric properties of the material are appropriate to sustain extra absorption modes at particular wavelengths. In one example, dielectric properties of the base material are chosen to allow absorption modes in the visible region of the electromagnetic spectrum.

Embodiments of the present invention provide an emitter including nanocavities in a base layer, where the base layer material includes hafnium and nitrogen. In one embodiment, the emitter includes a base layer with an emissive region having a periodic two-dimensional array of nanocavities. In one embodiment, the emitter is temperature stable at temperatures at about 1700 degree K and above. In a further embodiment, the emitter is temperature stable at temperatures at about 2000 degrees K. In a non-limiting example, the emitter is configured for operation at a temperature selected to be in a range from about 2000 K to 2500 K.

The hafnium and nitrogen may be present in the base layer material in a stoichiometric mix such as HfN or in a non-stoichiometric mix such as HfN_{α}, where α is less than or greater than 1. In some embodiments, other materials such as but not limited to carbon, oxygen, zirconia, may be present at impurity levels.

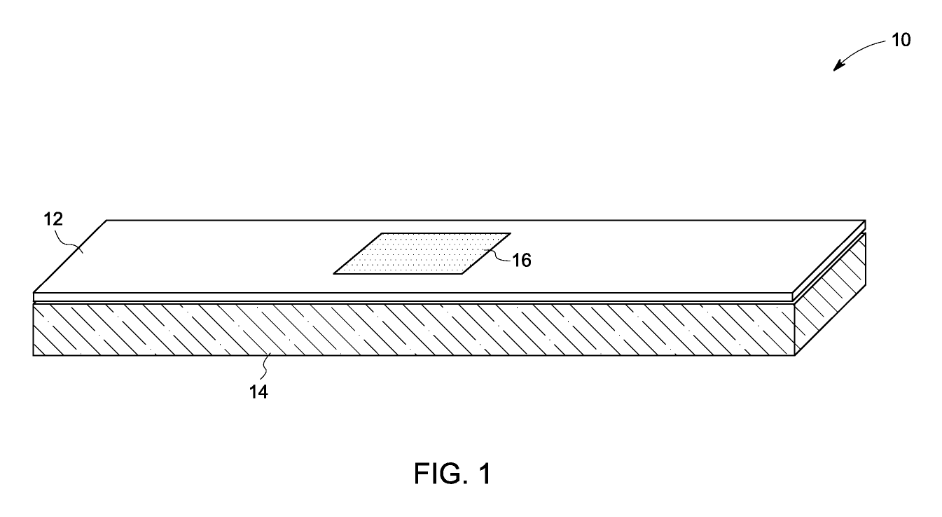

FIG. 1 illustrates a schematic view of an emitter 10 in accordance with one embodiment of the present invention. The emitter 10 includes a base layer 12 disposed over a support element 14. The base layer 12 includes an emissive region 16 including nanocavities. In one example, the base layer may be several microns thick. In some embodiments, a thickness of the base layer is chosen so as to retain the bulk properties of the material in the portion below the cavities. In one example, a thickness of the portion of the base layer below the cavities is 100 nm or above.

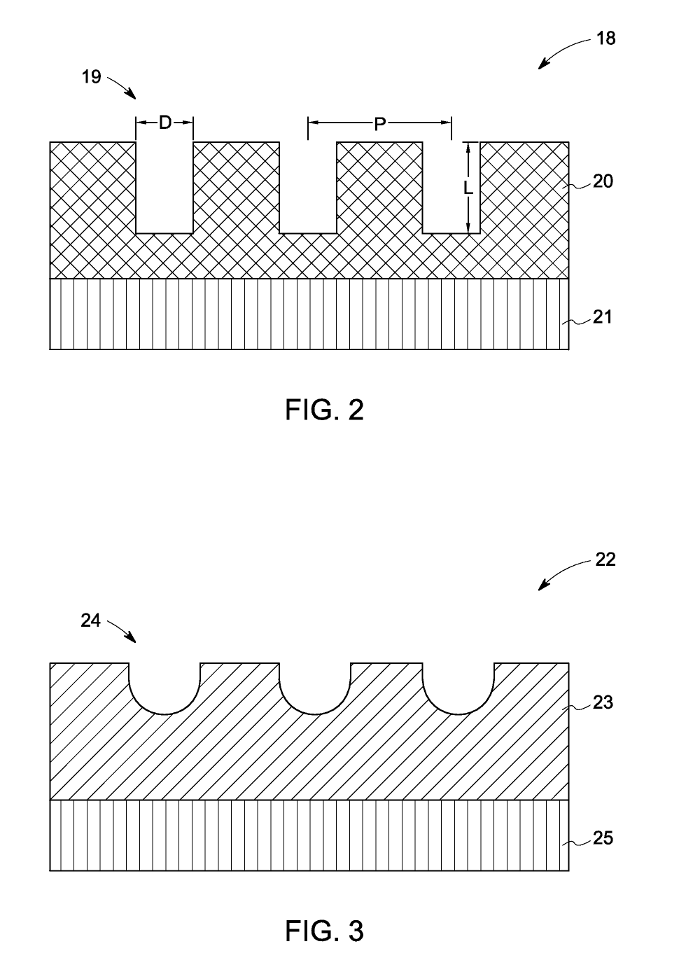

A cross-sectional view of an emissive region 18 is illustrated in FIG. 2 in accordance with one embodiment of the present invention. In the illustrated embodiment, the emissive region 18 includes open-end cylindrical cavities 19 formed in the base layer 20. The base layer is disposed over the support element 21. The nanocavities are defined by a pitch “P”, a diameter “D” and a depth “L”.

In one embodiment, desirable optical properties of the emitter, such as light emission, light transmission, and light suppression, may be tailored through the selection of parameters such as, but not limited to nanocavity geometry, nanocavity dimensions, and the periodicity of nanocavities.

As discussed above, cavity geometries and the dimensions affect the optical properties of the emissive region. The cavities may be of various geometries, regular and irregular. Cavities with regular geometries may have, for example, circular, triangular, rectangular, hexagonal or other geometrically shaped cross sections. The cavities may also be multi-faceted or have multiple planar surfaces at various angles to each other. The cross sections in some embodiments may also be irregular. Additionally, the cavities may not be geometrically precise. They cavities may have some variability in its shape and structure, for example, such as in the shoulders of the cavity holes and may have variations from an ideally flat cavity closed lower end.

Cavity dimensions, which may influence the optical properties include, but are not limited to, a major dimension of the cavity, such a width of the cavity or a depth of the cavity. In one embodiment, where for example, the cavity is a cylindrical cavity, a width of the cavity is equivalent to a cavity diameter and is in is in a range from about 200 nm to about 300 nm. In a further embodiment, the average cavity width of the nanocavities is in a range from about 240 nm to about 260 nm, for example 250 nm. In one embodiment, an average depth of the nanocavities is greater than about 300 nm, wherein the average depth is dimension as measured from an open end of the cavity to the closed end of the cavity. In certain embodiments, the average depth of the nanocavities is greater than about 500 nm.

The nanocavities may be of different geometries or shapes. In one non-limiting example, as illustrated in FIG. 2, a nanocavity geometry may be an open end cylinder. In another non-limiting example, a nanocavity geometry may be hemispherical. One such nanocavity geometry is illustrated in FIG. 3. FIG.3 illustrates a cross-sectional view of an emissive region 22 in accordance with one embodiment of the present invention. In the illustrated embodiment, the emissive region 22 includes hemispherical cylindrical cavities 24 formed in the base layer 23. The base layer 23 is disposed over a support element 25. In one embodiment, as the base layer thickness may be only a few microns, the support element or substrate is used to provide robustness to the emitter. In some further embodiments, the support elements acts as the thermal heater element for the base layer.

In one embodiment, an average periodicity or pitch of the nanocavities in the periodic array is in a range from about 400 nanometers to about 800 nanometers. In certain embodiments, an average periodicity of the nanocavities in the periodic array is in a range from about 500 nanometers to about 600 nanometers. In one embodiment, the average periodicity is 500 nanometers.

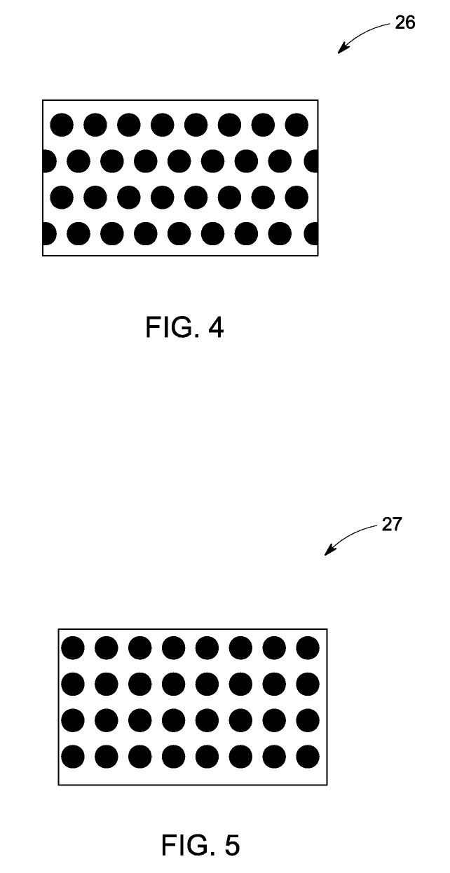

The nanocavities may be arranged in various lattice structures. FIG. 4 illustrates a top view of an emissive region 26 with a hexagonal lattice of nanocavities. In contrast in FIG. 5, an emissive region 27 with nanocavities in a simple square lattice arrangement is illustrated.

As discussed above, the emission properties may be tailored by varying the geometry and dimensions of the nanocavities. In one embodiment, the emitter exhibits selective emissivity in a range from about 390 nanometers to 750 nanometers. In one exemplary embodiment, the absorption modes of the nanocavities are centered at about 560 nm. In one embodiment, the net emissivity of the emitter may be a combination of emissivities of the base layer and the nanocavities formed in the base layer.

Although the Applicants do not wish to be bound by any particular theory, it is believed that in order to keep the low emissivity of the base layer material unaffected by the periodic array of the nanocavities, a width of the absorption modes should not extend beyond 750 nm.

In one embodiment, a base layer material may have an emissivity in the near infrared (750-2500 nm) spectral range that is substantially lower than that of a tungsten emitter, which is a standard reference emitter and which emits only 5-10% of radiation in the visible spectral range (390-750 nm). The rest is emitted as thermal infrared radiation, primarily in the 750-4000 nm spectral range.

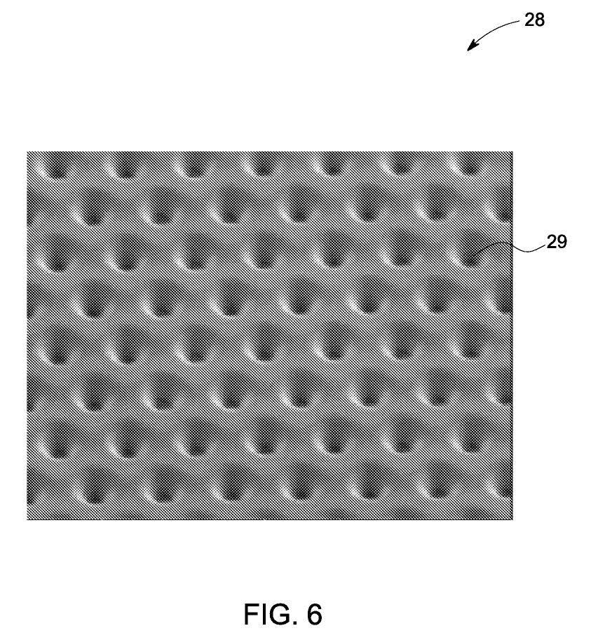

Several different methods may be used to form the emissive region with the nanocavities. In one embodiment, a focused ion beam technique (FIB) may be used to form the nanocavities. A FIB system uses a finely focused ion beam. As the beam hits the surface of the base layer, a small amount of material is sputtered, or dislodged, from the surface. Because of the high precision of the technique, it can be used to form nanocavities with desired dimension and depth and at desired geometries and periodicities. The nanocavities may still exhibit some variations or irregularities in the dimensions and geometries as discussed earlier. FIG. 6 is a micrograph of a hafnium nitride emitter 28 including a periodic array of nanocavities 29 in accordance with one embodiment of the present invention formed using an FIB technique. The nanocavities have an average pitch of P=750 nm, an average diameter D=250 nm and an average cavity depth greater than 1000 nm. Other suitable techniques for fabricating the nanocavities include but are not limited to laser drilling and sand blasting.

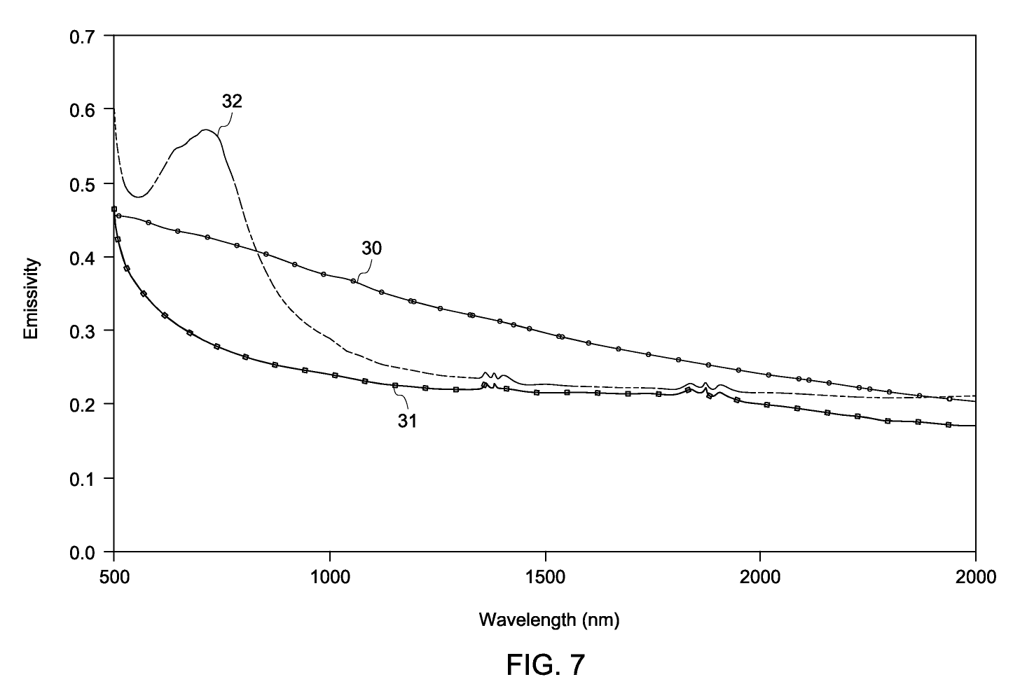

FIG. 7 illustrates the normal spectral emissivity for a tungsten emitter, a hafnium nitride emitter and a hafnium nitride emitter with an emissive region of periodic array of nanocavities, measured at a temperature about of 2273 degree K, in accordance with one embodiment of the present invention. A tungsten emitter was used as a reference emitter. Line plot 30 illustrates the variation in emissivity with wavelength for tungsten. Tungsten exhibits a broad emission spectrum and is not an efficient emitter in the visible region as it has considerable emissivity in the infrared region. Although hafnium nitride emission, which is represented by line plot 31, has low value in the infrared region, it also has peak emission wavelengths well below 500 nm. An emissive region with nanocavities was formed in a hafnium nitride material and the spectral emissivity variation was measured. The dimensions of the nanocavities correspond to the structure depicted in FIG. 6. Line plot 32 shows the variation in emissivity with wavelength for a hafnium nitride layer with an emissive region including the nanocavities. The line plot indicates an emissivity peak closer to 750 nm and an emissivity below 500 nm. The emissivity is quite low in the near infrared region.

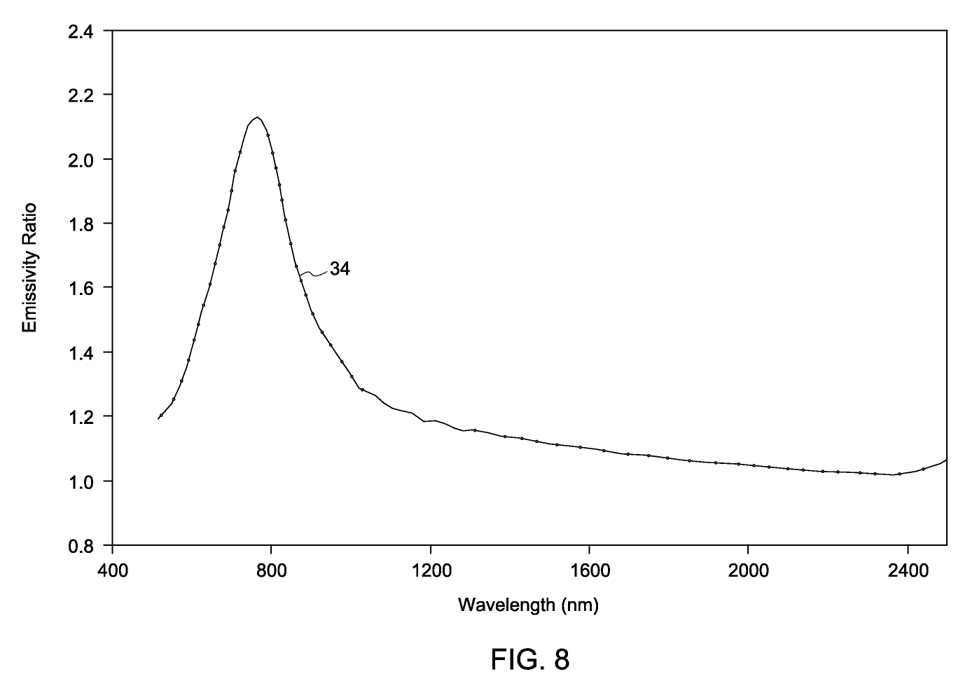

To understand better the emission properties of the nanocavities, a ratio of the emissivity of the nanocavities to the base material (HfN) was plotted as illustrated in FIG. 8, in accordance with one embodiment of the present invention. Line plot 34 in FIG. 8 captures the variation of the emissivity ratios with wavelength. The line plot peaks close to 800 nanometers, clearly illustrating that upon formation of the nanocavities in the hafnium nitride material, the emission wavelengths are shifted towards the red and infrared regions of the electromagnetic spectrum.

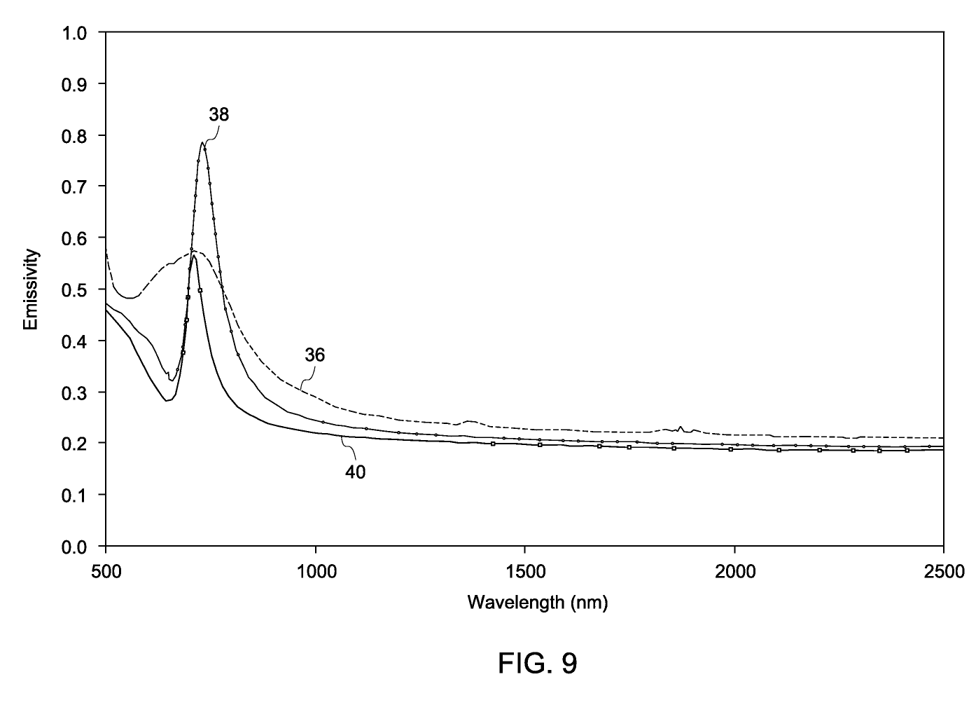

FIG. 9 is a comparative plot of measured emissivity and simulated emissivity for hafnium nitride periodic array of nanocavities with varying diameters, in accordance with one embodiment of the present invention.

Line plot 36 illustrates the measured variation in emissivity with wavelength for a hafnium nitride layer with an emissive region including the nanocavities, similar to line plot 32 in FIG. 7. Lines plots 38 and 40 are the line profiles of the calculated emissivity due to both surface and volume modes for a pitch of 750 nm and a diameter of 300 nm and 250 nm respectively. It is seen from the plots that for the given material and pitch values, the emissivity peaks shift to the higher wavelengths for smaller nanocavity diameters. The simulated emission peak for a base layer with an emission region with 250 nm diameter cavities is at about 750 nm, while the simulated emission peak for a base layer with an emission region with 300 nm nanocavities is at about 700 nm. Therefore, the optical emission properties of the emitter can be varied by varying the nanocavity geometry, nanocavity dimensions, and the periodicity of nanocavities.

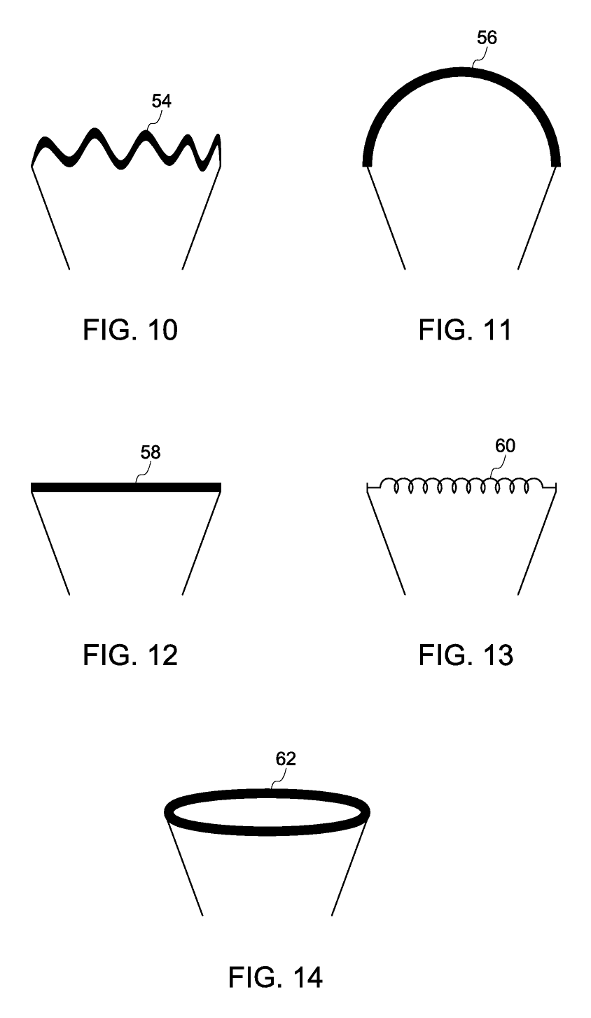

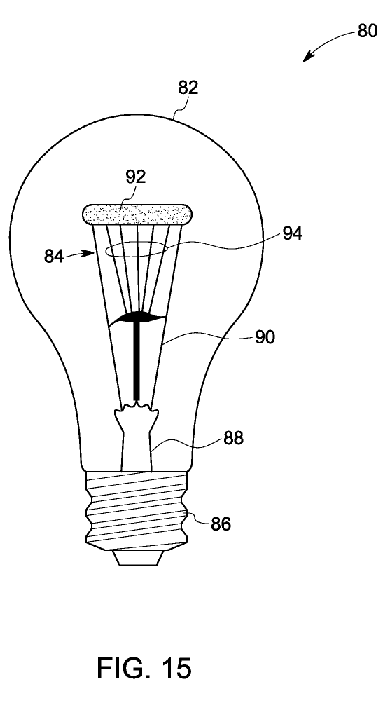

The emitter may be formed in various shapes and structures such as but not limited to a planar structure, a solid or hollow cylindrical structure or a coiled structure. Non-limiting examples of various emitter structures are illustrated in FIGS. 10 though 14. The emitter structures depicted in FIGS. 10 through 14 are intended to be illustrative and not limiting. In one example, the emitter may be a planar ribbon element 54 as shown in FIG. 10. The emitter of FIG. 11 is a curved element 56. In another example, the emitter may be a planar structure 58 as shown in FIG. 12. The emitter illustrated in FIG. 13 represents a coiled element 60 which may be formed in a coiled-coil arrangement. In a further example, the emitter may be a planar annular element 62 as shown in FIG. 14.

In some embodiment, the emitter may include a support element as seen in FIGS. 1 and 2. The support element may include materials such as, but not limited to, a metal, a metal alloy, a ceramic and metal-doped ceramic. In one example, the support element may be made of tungsten.

In one embodiment, the emitter may include a plurality of base layers. The emissive regions in the plurality of base layers may have the same or different emission characteristics.

In another embodiment, the emitter may include a plurality of emissive regions. The nanocavities in each of the emissive regions may have the same or different emission characteristics.

In accordance with another aspect of the present invention, the emitters disclosed herein may be employed in systems such as radiation sources. Non-limiting examples of such systems include light sources such as lamps. In one embodiment, the emitter may be employed in an incandescent lamp. In a further embodiment, the radiation emitter structure may include electrical leads to supply electrical energy to the emitter. The emitter and the electrical leads may form a unitary structure or the electrical leads may be separately manufactured.

In one embodiment, a radiation source may include a base, a light-transmissive envelope coupled to the base, and an emitter including a base layer. The base layer includes an emissive region of a periodic two-dimensional array of nanocavities and the base layer includes a material including hafnium and nitrogen.

FIG. 15 illustrates a radiation source such as an incandescent lamp including the emitter in accordance with one embodiment of the present invention. As illustrated in FIG. 15, incandescent lamp 80 may include a base 86, a light-transmissive envelope 82, a radiation emitter structure 84 disposed within the light transmissive envelope 82, and a base 86 to which the light transmissive envelope 82 is coupled. The base 86 is where the electrical contact for the lamp is made and as such, may be fabricated out of any conductive material such as brass or aluminum. The light-transmissive envelope 82 may be fabricated out of glass and may take on any of a wide variety of shapes and finishes.

The radiation emitter structure 84 may be coupled to the base 86 and may include a stem press 88 lead wires 90, and support wires 94. The radiation emitter structure 84 may further include an emitter 92 coupled to the base 86. In the illustrated embodiment of FIG. 15, the emitter is a unitary structure made of for example hafnium nitride with an emissive region including nanocavities. The emitter may or may not include a support element. The lead wires 90 carry the current from the base 86 to the emitter 92. The lead wires 90 may be made of copper from the base 86 to the stem press 88 and may be made of nickel or nickel-plated copper from the stem press 88 to the emitter 92. The stem press 88 may be a glass-based structure that holds the radiation emitter structure 84 in place. The stem press 88 may include an airtight seal around the lead wires 86. In order to balance the coefficients of expansion, the stem press 88 may further include a copper sleeve through which the lead wires 90 are passed. The support wires 94 are used to support the emitter 92 and may be made from molybdenum, for example.

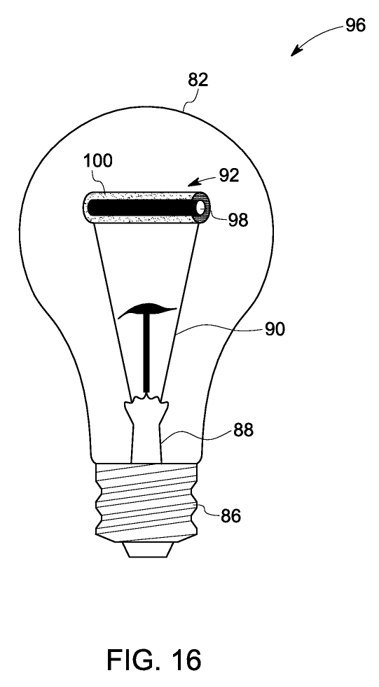

In the embodiment illustrated in FIG. 16, the incandescent lamp 96 is substantially similar to the incandescent lamp 80 of FIG. 15. However, the radiation emitter structure 84 of the incandescent lamp 96 includes an emitter 92 that in turn includes a base layer 100 disposed over a core or support element 98. Emitters may have various structures as described above. For example, the emitter may be a coiled element or a planar element. In one non-limiting example, the emitter may be a double-coiled element including core 98 with the coating or base layer 100.

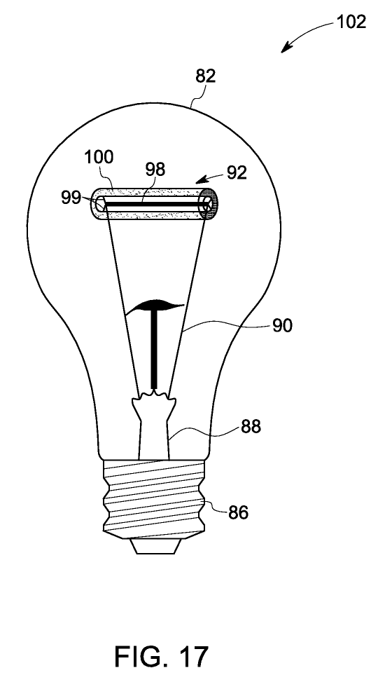

In another non-limiting example, the base layer may form an emitter with no direct electrical contact with a core or support element forming a filament. The emitter may be mechanically supported by the core but not electrically connected to it. The emitter may therefore be indirectly heated by the radiation from the core to in turn emit radiation. FIG. 17 illustrates one such embodiment 102, where the emitter 100 is not in direct with the core 98. In the illustrated example, the emitter 100 is supported by insulating supports 99.

In a further embodiment, a gas filling may be disposed within the light transmissive envelope. Non-limiting examples of such gas fillings include noble gases such as but not limited to argon, krypton and gases such as nitrogen. In one example the gas filling may include 95% argon and 5% nitrogen.

In one embodiment, the gas filling may be chosen to be non-reactive to the emitter material. In an alternative embodiment, the gas filling may be chosen, such that thermodynamic equilibrium is achieved during operation between the gas filling and the material of the emitter.

The emission quality of radiation sources may be characterized by parameters such as color rendition index (CRI) and color temperature. CRI is a measure of the ability of a light source to reproduce the colors of various objects being lit by the source. In various embodiments including the emitters described herein, the color rendition index (CRI) of the radiation source is typically in a range from about 60 to about 100. In some embodiments, the CRI is greater than 75. In some further embodiment, the radiation source has a CRI greater than about 80 during operation. In still further embodiments, the CRI is greater than 90.

Color temperature of a radiation source is determined by comparing the color of the source with a theoretical, heated black-body radiator. In some embodiments of the radiation source including the emitter described herein, the color temperature of the radiation source is greater than about 2000 degrees K. In some further embodiments, the color temperature of the radiation sources is greater than 2500 degrees K.

While only certain features of the invention have been illustrated and described herein, many modifications and changes will occur to those skilled in the art. It is, therefore, to be understood that the appended claims are intended to cover all such modifications and changes as fall within the true spirit of the invention.

1. An emitter comprising:
a base layer, wherein the base layer comprises an emissive region of nanocavities and wherein the base layer comprises hafnium and nitrogen.

2. The emitter of claim 1, wherein the emissive region of nanocavities comprises a periodic two-dimensional array of nanocavities.

3. The emitter of claim 2, wherein an average periodicity of the nanocavities in the periodic array is in a range from about 400 nanometers to about 1000 nanometers.

4. The emitter of claim 3, wherein the average periodicity of the nanocavities in the periodic array is in a range from about 500 nanometers to about 600 nanometers.

5. The emitter of claim 1, wherein a nanocavity geometry is an open end cylinder.

6. The emitter of claim 1, wherein a nanocavity geometry is a hemispherical cavity.

7. The emitter of claim 1, wherein an average hole dimension of the nanocavities is in a range from about 200 nm to about 300 nm.

8. The emitter of claim 7, wherein the average hole dimension of the nanocavities is in a range from about 240 nm to about 260 nm.

9. The emitter of claim 1, wherein an average depth of the nanocavities is greater than about 300 nm.

10. The emitter of claim 9, wherein an average depth of the nanocavities is greater than about 500 nm.

11. The emitter of claim 1, wherein the emissive region exhibits selective emissivity in a range from about 390 nanometers to 750 nanometers

12. The emitter of claim 1, wherein absorption modes of the nanocavities are centered at about 560 nm.

13. The emitter of claim 12, wherein width of the absorption modes does not extend substantially beyond about 750 nm.

14. The emitter of claim 1, wherein the two-dimensional periodic array is a simple square lattice.

15. The emitter of claim 1, wherein the two-dimensional periodic array is a hexagonal lattice.

16. The emitter of claim 1, further comprising a support element, wherein the base layer is disposed as a coating over the support element.

17. The emitter of claim 16, wherein the support element comprises a coiled element.

18. The emitter of claim 16, wherein the support element comprises a planar or a cylindrical element.

19. The emitter of claim 16, wherein the support element comprises a material comprising a metal, a metal alloy, a ceramic, a metal doped ceramic or combinations thereof.

20. The emitter of claim 16, wherein the support element comprises tungsten.

21. The emitter of claim 16, wherein, the support element comprises a thermal heater element for the base layer.

22. The emitter of claim 1, wherein the emitter is configured for operation at a temperature in a range from about 2000 K to 2500 K.

23. The emitter of claim 1, wherein the emitter comprises a plurality of base layers.

24. The emitter of claim 1, wherein the emitter comprises a plurality of emissive regions.

25. A radiation source comprising:
a base;
a light-transmissive envelope coupled to the base; and
an emitter comprising a base layer, wherein the base layer comprises an emissive region of a periodic two-dimensional array of nanocavities, wherein the base layer comprises hafnium and nitrogen.

26. The radiation source of claim 25, further comprising a gas phase.

27. The radiation source of claim 26, wherein the gas phase comprises argon.
